(19) United States
(12) Patent Application Publication
(10) Pub. No.: US 2007/0053425 A1
(43) Pub. Date: Mar. 8, 2007

(54) Variable length codes for scalable video coding

(75) Inventors: Justin Ridge, Irving, TX (US); Marta Karczewicz, Irving, TX (US); Yiliang Bao, Irving, TX (US); Xianglin Wang, Santa Clara, CA (US)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/490,384

(22) Filed: Jul. 20, 2006

Related U.S. Application Data
(60) Provisional application No. 60/701,264, filed on Jul. 21, 2005.
(60) Provisional application No. 60/723,060, filed on Oct. 3, 2005.

(51) Int. Cl. H04B 1/66

(52) U.S. Cl. 375/240

(57) ABSTRACT

A method for coding spatial and quality enhancement information in scalable video coding using variable length codes. Conventional systems have been capable of using variable length codes only with nonscalable video coding. In the present invention, the coded block pattern for each block of information, significance passes, and refinement passes can all be coded with different types of variable length codes.

### CROSS-REFERENCE TO RELATED APPLICATIONS

The present application claims priority to U.S. Provisional Patent Application No. 60/701,264, filed Jul. 21, 2005 and U.S. Provisional Patent Application No. 60/723,060, filed Oct. 3, 2005, both of which are incorporated herein by reference in their entirety.

### FIELD OF THE INVENTION

The present invention relates generally to scalable video coding. More particularly, the present invention relates to scalable video coding.

### BACKGROUND OF THE INVENTION

Conventional video coding standards such as MPEG-1, H.261/263/264, etc. encode video either at a given quality setting, often referred to as “fixed QP encoding,” or at a relatively constant bit rate via the use of a rate control mechanism. If, for some reason, the video needs to be transmitted or decoded at a different quality, then the data must first be decoded and then re-encoded using the appropriate setting. In some scenarios, e.g. in low-delay real-time applications, such “transcoding” may not be feasible.

Similarly, conventional video coding standards encode video at a specific spatial resolution. If the video needs to be transmitted or decoded at a lower resolution, then the data must first be decoded, spatially scaled, and then re-encoded. Again, such transcoding is not feasible in some scenarios.

Scalable video coding overcomes these issues by coding a “base layer” with a minimum spatial resolution and quality, and then coding enhancement information that increases spatial resolution and/or quality up to a maximum level. Therefore, a reduction in spatial resolution may be achieved by simply discarding the spatial enhancement information, without the need to transcode. For quality enhancement, the information may often be truncated at discrete (but closely-spaced) points, affording additional flexibility by permitting intermediate qualities between the “base” and “maximum” to be achieved.

The current scalable extension to H.264/AVC employs CABAC, a type of arithmetic coder, when decoding spatial and quality enhancement information. CABAC is an alternative entropy coding method to variable length codes (VLCs). Although CABAC generally has a coding efficiency benefit, it is understood that there are a number of disadvantages associated with it, such as increased decoder complexity. Furthermore, no VLC alternative is provided for the current scalable extension to H.264/AVC. The non-scalable H.264/AVC standard supports both CABAC and VLCs, recognizing that each has advantages and disadvantages, and allowing for the method most suitable to a specific application to be selected.

### SUMMARY OF THE INVENTION

This invention provides a method for decoding spatial and quality (FGS) enhancement information using variable length codes. The present invention provides a solution using VLCs in scalable video coding, which has not previously existed. Although the use of VLCs may entail a slight loss (in the range of about 10%) in computational efficiency, this loss is offset by improvements in coder complexity. In fact, the observed tradeoff for enhancement layers is quite similar to the tradeoff that has already been accepted for the non-scalable H.264/AVC standard.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view of a mobile telephone that can be used in the implementation of the present invention; and

FIG. 2 is a schematic representation of the telephone circuitry of the mobile telephone of FIG. 1.

### DETAILED DESCRIPTION OF THE PREFERRED EMBODIMENTS

Generally, quality enhancement information can be divided into three categories: coded block pattern, significance pass, and refinement pass. For the coded block pattern, a “coded flag” is decoded for each macroblock (MB), or for a region of the macroblock, such as an 8×8 region “sub-MB.” The flag only needs to be decoded if the “coded flag” for the corresponding macroblock in all lower layers was zero, i.e. if the MB was not coded in the base layer or other lower layers.

For MBs (or sub-MBs) that are flagged as “coded,” the coded block pattern (CBP) for each 4×4 block within the MB (or sub-MB) is then decoded. In each 8×8 region of a MB, there are four 4×4 blocks, for example. A binary number can be used to indicate which of the 4×4 blocks contain coefficients to be encoded. The number 0101 can indicate that the top-left 4×4 block has no coefficients to be decoded, the top-right 4×4 block was encoded, the bottom-left was not encoded, and the bottom-right was encoded. If the 4×4 block was already flagged as coded in the base layer, no CBP value is decoded. Therefore, unlike non-scalable H.264/AVC, the number of bits in the CBP may vary. Using the above example, if the bottom-right 4×4 block was already encoded in the base layer, the last bit of the CBP is unnecessary and the CBP becomes 010.

A VLC is used to decode the CBP. The specific VLC that is used depends upon the number of bits in the CBP. The VLC is therefore “context adaptive” (CAVLC), where the context (i.e. the VLC used) is provided by the CBP of the base layer. The context decision can also be affected by the CBP of spatially neighboring blocks in the base and/or enhancement layers. It is also possible for the context decision to be based at least in part upon the number of coded coefficients in neighboring blocks, or by the positions of coded coefficients in neighboring blocks in the enhancement layer.

The VLCs that may be used may be custom designed or may comprise “structured” VLCs such as Golomb codes. A Golomb code is variable-length code that is based on a simple model of the probability of values, where small values are more likely than large values.

Significance bits are decoded whenever a coefficient was zero in all lower layers, i.e. it has not been decoded up to the current layer. The significance bit indicates whether the coefficient is zero or nonzero. If the coefficient is nonzero, then the sign and magnitude follow.

In the present invention, the number of zeros (i.e. the run) is encoded before the next significant coefficient. For example, if the base layer contains values 1 0 1 0 0 1, and the enhancement layer contains values 1 0 2 0 1 1, then the first, third and sixth coefficients are disregarded for the purpose of decoding significance bits, as they were non-zero in the base layer. Thus the values to be decoded are 0 0 1. In this case, the “run” of zeros before the non-zero value is two. The term “scan position” is defined herein as the index of the coefficient where the run begins. In the above example, the first coefficient is ignored, so the first zero value decoded is at scan position two. The VLC used to decode the “run” is also context-adaptive and depends on the scan position, the number of coefficients coded in the base layer (three, in the above example), the index of the last coefficient coded in the base layer (six, in the above example), or a combination of the three. It should also be noted that the present invention can involve the VLC as not being structured (i.e., where an arbitrary VLC is selected), as well as the more narrow situation where “structured” VLCs, such as Golomb codes or start-step-stop codes are used.

In a particular embodiment of the present invention, a mapping of the context criteria to the optimal VLC is decoded from the bit stream. This could occur, for example, once per slice (in the slice header) or once per frame. It may specify that “for scan position #1 use a Golomb code with k=1”, “for scan position #2 use a Golomb code with k=1”, “for scan position #3 use a Golomb code with k=2”, etc. Determining which context criteria maps to which VLC may be accomplished by “pre-scanning” the data before encoding, or by utilizing statistics of previously encoded data (e.g. the previous frame).

In yet another embodiment of the present invention, the mapping of context criteria to VLC is coded in an efficient manner. To achieve this, the possible VLCs are ordered in a regular fashion. For example, the possible VLC's could be ordered from “most peaked” probability distributions (high peak at the first symbol value) to the “least peaked”, or flatter distributions. The VLCs themselves are given indexes. For example, the first VLC may be a Golomb code with parameter k=1, the second VLC may be a Golomb code with parameter k=2, etc. By then forcing the VLC to be a monotonic (increasing or decreasing) function of the context selection criteria, there is an overall improvement in coding efficiency. This efficiency occurs even though there is a slight loss of optimality in VLC selection. Using the above example, the VLCs used for scan positions 1, 2 and 3 would be 1, 1 and 2 respectively, which can be written as 1 1 2. Sequences such as 1 2 1 are not permitted since they are not monotonic. Due to the monotonic nature of the function, only the starting VLC and the position of the step need to be decoded. For example, rather than explicitly decoding the values “1 1 2”, the starting VLC (“1”) can be decoded, followed by the number of those values before a step to the next level.

The embodiment described above can be extended to a situation where there are two or more context selection criteria. This can be accomplished by drawing the mapping function as a two (or ‘n’) dimensional table and enforcing monotonicity along each dimension. In another example, the VLC is selected based upon both the scan position as well as the position of the last nonzero base layer coefficient. In this case, the mapping for optimal VLCs may be, for example:

1 1 2

2 2 2

1 2 2

In this table, the first row corresponds to the case where the last nonzero base layer coefficient (LNZBC) was at position 1, the second row corresponds to the case where the LNZBC was at position 2, etc. It should be noted that each row monotonically increases, but the first column does not. By enforcing this constraint, the table can be rewritten as:

1 1 2

2 2 2

2 2 2

or alternatively as

1 1 2

1 2 2

1 2 2

In this situation, the run-level coding can be applied along each dimension. For example, the first row can be decoded as described above. The starting position can then be used from the first row when decoding each column. When implemented, this avoids coding of most values except for the upper-left corner of the matrix.

In still another embodiment of the present invention, an end-of-block (EOB) marker is used to indicate that there are no more coefficients that need to be decoded in the significance pass for a given block. The EOB is treated as another possible run length (with notional value −1) when decoding the significance bits.

For structured VLCs, the lowest-valued symbols should have the highest probability. In some cases, the EOB does indeed have the highest probability of all symbols, but this is not always the case. This can be overcome by decoding from the bit stream (e.g. slice header) values indicating the EOB symbol position in the VLC. This can be performed once or, to achieve further coding efficiency gains, can be performed once for some or all of the context selection criteria. For example, it can be decoded once for each scan position. The same monotonicity constraint and decoding method may be applied for decoding the EOB symbol position as described above for the VLC mapping. In still another embodiment, the EOB symbol may be designated as having very low probability for some context criteria. To improve coding efficiency, a distinct symbol may be decoded indicating the number of such “low probability” EOB symbols. Decoding of the remaining EOB symbols then follows as described previously.

The above text has focused on decoding the positions of significant coefficients, without considering the sign or magnitude of the terminating values. In general, most values have a magnitude of zero or one. Magnitudes of two to four are also possible.

One method of improving coding efficiency is to divide the significance bits into two passes. On the first pass, no magnitude is decoded. Instead, only position information and the sign flag is decoded. The magnitude of significant coefficients is assumed to be one. On a second pass, the positions of coefficients with higher magnitudes are encoded. For example, if one were to decode values 0 0 1 0 0-3 1 0, the values 0 0 1 0 0-1 1 1 0 would be initially decoded. In this situation, there are three significant coefficients with magnitude one. Then in a second pass, a “two” is decoded, indicating that the second of the unit-magnitude coefficients in reality has a larger magnitude (a magnitude of 3 in this case). After identifying the position of the larger-magnitude coefficient, the precise magnitude (e.g., 2, 3 or 4) is decoded. One fixed VLC may be used for this purpose: In another embodiment of the invention, this VLC itself may be context-adaptive and selected based upon criteria such as the scan position, number of unit magnitude values, dead zone size, enhancement layer number, other factors, and a combination of such factors. In another embodiment of the invention, the process is iterated so that coefficients with a magnitude of 2 are decoded on a second pass, coefficients with a magnitude of 3 are decoded on a third pass, and coefficients with a magnitude of 4 are decoded on a fourth pass. This iterative process obviates the need to decode magnitude information in each cycle.

Lastly, refinement bits are transmitted when the coefficient is non-zero in a lower layer. Refinement bits comprise magnitude and sign information. Refinement bits are grouped into fixed-size lots. In one particular embodiment of the invention, the refinement bits are grouped into lots of three, although other sizes may be used. For example, in three bit groupings, if the refinement bits are 0 0 0 1 1 0 1 0 0 1, then this would be grouped into [0 0 0] [1 1 0] [1 0 0] [1]. It should be noted that the last set may contain fewer than three values. The symbols corresponding to the binary values are then encoded using a VLC. In the example above, the symbols 0, 6, 4, and 1 are encoded.

The VLC used to encode the symbol is either decoded from the bit stream, is inferred from previously decoded data, or is based upon the FGS layer number. The possible VLCs are structured in decreasing order of probability of zero. For example, in a VLC reflecting a higher probability of zero, the shortest codeword is used to represent the value 000, the next-shortest codewords for the values 001, 010, 100, etc. The lowest probability of a zero symbol is the 50% case, when the symbol and the codeword are equivalent.

When the last symbol is encoded, only flags are used (and no VLC) since the loss of efficiency is marginal. It is also possible for the last codeword to either be padded, or for a different VLC (selected based on the VLC used for other values) to be used.

Sign bits are encoded in a manner similar to that described above. However, there tends to be only two cases for sign bits; the distribution tends to either be skewed towards zero for the first enhancement layer, or towards 50% ones and 50% zeros for subsequent enhancement layers. The VLC is therefore dependant on the enhancement layer number. In the 50/50 case, flags are encoded rather than the values being grouped.

With the present invention, the encoding of spatial enhancement information is generally similar to the regular, non-scalable encoding under H.264/AVC. However, additional and/or different VLCs can be used when encoding spatially upsampled information, and that the context that is used can be based on lower-layer information rather than the spatial neighbors.

In another embodiment, the present invention is applied to the decoding of Coded block flags (CBFs). CBFs indicate whether a region within a macroblock contains values to be decoded or not. In the existing FGS for H.264/AVC, CBFs are decoded independently. However, a coding efficiency gain can be realized by decoding multiple CBFs simultaneously, as for CBPs. The probability of previous CBFs being zero or one is measured, and this information is used to select a VLC for decoding. This is accomplished in the same manner as is the case for CBPs. Bit flipping is also used. It should be understood that, although text and examples contained herein may specifically describe an decoding process, one skilled in the art would readily understand that the same concepts and principles also apply to the corresponding encoding process and vice versa.

In one embodiment, when coding a vector of CBF values, the CBFs from corresponding blocks in the base layer are utilized in determining the VLC to be used. In another embodiment, the CBF values from corresponding blocks in the base layer are utilized in segmenting the enhancement layer CBF. For example, in a similar manner to the CBP, values CBF0 and CBF1 might be formed, with CBF0 containing enhancement layer CBF values for which the base layer CBF was zero, and CBF1 containing enhancement layer CBF values for which the base layer CBF was one. These segmented CBF values may be coded individually, for example, using a method substantially identical to the method for coding a segmented CBP.

In another embodiment, the present invention is applied to the decoding of FGS information in H.264/AVC, and more specifically to the decoding of end of block (EOB) markers in the significance pass. Presently, H.264/AVC uses a single EOB symbol to indicate whether there are non-zero values remaining in the block. The present invention involves the use of multiple EOB symbols, with some or all of the EOB symbols used indicating information about the magnitude of coefficients from that block that were designated as “significant” during the significance pass. This information may include the number of coefficients in the block with a magnitude greater than one. Alternatively, the information may include the maximum magnitude of coefficients decoded in the significance pass. The information could also include a combination of both of these items.

The number of coefficients in the block with a magnitude greater than one (x) and the maximum magnitude of coefficients decoded in the significance pass (y) may be combined using a separable linear function, such as EOBoffset=16y+x. In this situation, in the decoding process, y=EOBoffset/16 and x=EOBoffset % 16, i.e., x is the remainder when EOBoffset is divided by 16. In some cases, a combination of linear functions may be used. For example, EOBoffset=2x+y % 2, if y<4 and EOBoffset=16y+x otherwise.

The number of decoded coefficients (z) may also be incorporated into the linear equation. For example, in one embodiment, EOBoffset 2(x−1)+y % 2, if y<4 and EOBoffset=z(y−2)+x−1, otherwise. Therefore, in the decoding process, x=(EOBoffset/2)+1, y=(EOBoffset % 2)+2, if EOBoffset<2z and x=(EOBoffset % z)+1, y=(EOBoffset/z)+2, otherwise.

The present invention therefore covers the particular case where (1) one EOB symbol is used to indicate an end of a block where no coefficient decoded in the significance pass has a magnitude greater than one; and (2) the remaining EOB symbols indicate not only an end of block condition, but additionally indicate the number of coefficients with magnitude greater than one and the maximum magnitude.

In one embodiment of the invention, the actual symbols used as EOB markers that include magnitude information, are arbitrary but known to the decoder. For example, these markers can be fixed during codec design or explicitly indicated in the bit stream, In this case, the decoded symbol is located in a mapping table. The index of the symbol provides the value of EOBoffset to be used in the above equations. For example, if the symbol “9” is decoded, then, according to the example in Table 1 below, EOBoffset=1. Through the use of the linear equations above, the values of x and y may then be determined.

TABLE 1

| EOBoffset | EOB symbol |
|---|---|
| 0 | 6 |
| 1 | 9 |
| 2 | 3 |
| 3 | 1 |
| 4 | 15 |
| 5 | 12 |
| 6 | 7 |
| 7 | 10 |

In one particular embodiment of the invention, the EOB symbols that incorporate magnitude information are sequential. In this case, after decoding a symbol, the first EOB symbol is subtracted from the decoded symbol to give EOBoffset. An example of EOB sequential values is depicted in Table 2. In this case, if the EOB symbol “9” is decoded, then the value “6” is subtracted to give EOBoffset=3.

TABLE 2

| EOBoffset | EOB symbol |
|---|---|
| 0 | 6 |
| 1 | 7 |
| 2 | 8 |
| 3 | 9 |
| 4 | 10 |
| 5 | 11 |
| 6 | 12 |
| 7 | 13 |

In another embodiment of the invention, the EOB symbols containing magnitude information are not only sequential, but start from the first “illegal” run length. For example, if a block contains 16 coefficients, but 10 coefficients have been already processed, then the maximum “run” of zeros before the next non-zero value is 5. It is not possible for a “run” of length 6 or greater to occur, so symbols 6 and greater are considered “illegal”. In this situation, the EOB symbols containing magnitude information would be numbered sequentially starting at 6. In this embodiment, the symbol used for a given EOBoffset may vary from one block to another.

In another embodiment of the present invention, the symbol indicating an EOB and no magnitudes greater than one may be bounded by the first illegal symbol. For example, if the symbol “5” is assigned to indicate an EOB where no magnitudes are greater than one, and two coefficients remain to be coded in a block (so that “3” is the first illegal symbol), then the symbol “3” would be used rather than “5” to indicate an EOB with no coefficients of magnitude greater than one.

In still another embodiment of the present invention, the first EOB symbol indicating magnitudes greater than one is shifted by one depending upon whether the number of coefficients remaining to be coded exceeds the symbol signifying an EOB with no coefficients of magnitude greater than one. For example, if the symbol “5” is assigned to mean an EOB where no magnitudes are greater than one, and less than five coefficients remain to be coded, then the values in the “EOB symbol” column of Table 2 would be incremented by one.

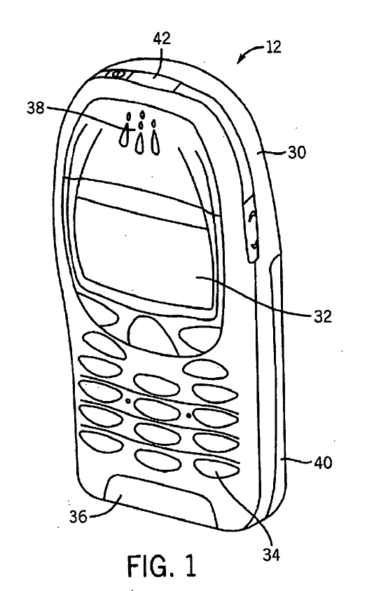

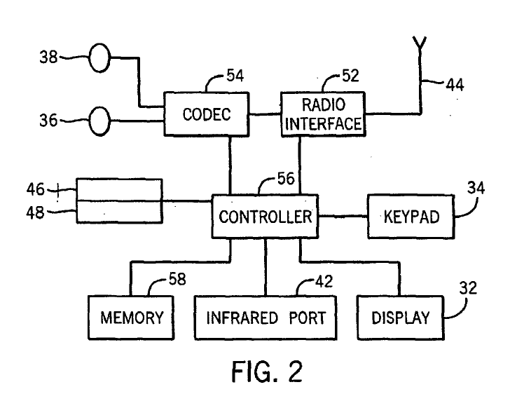

FIGS. 1 and 2 show one representative mobile telephone 12 within which the present invention may be implemented. It should be understood, however, that the present invention is not intended to be limited to one particular type of mobile telephone 12 or other electronic device. For example, the present invention can be incorporated into a combination personal digital assistant (PDA) and mobile telephone, a PDA, an integrated messaging device (IMD), a desktop computer, and a notebook computer. The mobile telephone 12 of FIGS. 1 and 2 includes a housing 30, a display 32 in the form of a liquid crystal display, a keypad 34, a microphone 36, an ear-piece 38, a battery 40, an infrared port 42, an antenna 44, a smart card 46 in the form of a universal integrated circuit card (UICC) according to one embodiment of the invention, a card reader 48, radio interface circuitry 52, codec circuitry 54, a controller 56 and a memory 58. A motion sensor 60 is also operatively connected to the controller 56. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. The present invention can be implemented directly in software using any common programming language, e.g. C/C++ or assembly language. This invention can also be implemented in hardware and used in consumer devices. It should also be noted that the words “component” and “module” as used herein and in the claims is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of decoding quality enhancement information in a video portion using variable length codes, comprising:
receiving a video portion including a base layer and a quality enhancement layer;
decoding significance values from the quality enhancement layer using a first variable-length code, the significance values indicating whether coefficients that were zero in the base layer and any previous enhancement layers are non-zero in the quality enhancement layer; and
decoding from the quality enhancement layer refinement bits using a second variable-length code, the refinement bits enabling coefficients that were non-zero in the base layer or any previous enhancement layer to be represented with greater precision.

2. The method of claim 1, wherein at least one of the first and second variable length codes comprises a structured code, the structured code selected from the group consisting of a Golomb code and a start-step-stop code.

3. The method of claim 1, further comprising:
decoding a coded flag for each macroblock in the quality enhancement layer if a coded flag for a corresponding macroblock in the base layer indicates that the corresponding macroblock in the base layer has not been decoded; and
for each macroblock in the quality enhancement layer having a corresponding coded flag that has been decoded, decoding a coded block pattern using a third variable length code for each block within the respective macroblock,
wherein the coded block pattern is formed using only those blocks that were not coded in the base layer or previous quality enhancement layers.

4. The method of claim 3, wherein the third variable length code used in decoding is selected at least in part based upon at least one of criteria selected from the group consisting of the number of bits in the coded block pattern and the probability of a bit in the coded block pattern being equal to one.

5. The method of claim 1, wherein decoding of significance values includes:
decoding a run of zero-valued significance values; and
terminating non-zero valued significance values.

6. The method of claim 5, wherein decoding the significance values includes:
an initial pass in which the magnitude of the terminating significance value is assumed to be one; and
zero or more subsequent passes in which the magnitude of terminating significance values is refined.

7. The method of claim 1, wherein the first variable length code is selected at least in part based upon at least one of criteria selected from the group consisting of the position of the coefficient corresponding to the start of a run of zero-valued significance values, and the position of the last non-zero coefficient in a corresponding block of the base layer or previous quality enhancement layers.

8. The method of claim 7, wherein a mapping of context criteria for an optimal code is decoded from the bit stream.

9. The method of claim 8, wherein the context mapping comprises a monotonic function.

10. The method of claim 5, wherein an end-of-block marker, indicating the absence of significant coefficients in the remaining positions of the block, is allocated a symbol in the first variable-length code.

11. A computer program product for decoding quality enhancement information in a video portion using variable length codes, comprising:
computer code for receiving a video portion including a base layer and a quality enhancement layer;
computer code for decoding significance values from the quality enhancement layer using a first variable-length code, the significance values indicating whether coefficients that were zero in the base layer and any previous enhancement layers are non-zero in the quality enhancement layer; and
computer code for decoding from the quality enhancement layer refinement bits using a second variable-length code, the refinement bits enabling coefficients that were non-zero in the base layer or any previous enhancement layer to be represented with greater precision.

12. The computer program product of claim 11, wherein at least one of the first and second variable length codes comprises a structured code, the structured code selected from the group consisting of a Golomb code and a start-step-stop code.

13. The computer program product of claim 11, further comprising:
computer code for decoding a coded flag for each macroblock in the quality enhancement layer if a coded flag for a corresponding macroblock in the base layer indicates that the corresponding macroblock in the base layer has not been decoded; and
computer code for each macroblock in the quality enhancement layer having a corresponding coded flag that has been decoded, decoding a coded block pattern using a third variable length code for each block within the respective macroblock,
wherein the coded block pattern is formed using only those blocks that were not coded in the base layer or previous quality enhancement layers.

14. The computer program product of claim 13, wherein the third variable length code used in decoding is selected at least in part based upon at least one of criteria selected from the group consisting of the number of bits in the coded block pattern and the probability of a bit in the coded block pattern being equal to one.

15. The computer program product of claim 11, wherein decoding of significance values includes:
decoding a run of zero-valued significance values; and
terminating non-zero valued significance values.

16. The computer program product of claim 15, wherein decoding the significance values includes:
an initial pass in which the magnitude of the terminating significance value is assumed to be one; and
zero or more subsequent passes in which the magnitude of terminating significance values is refined.

17. The computer program product of claim 11, wherein the first variable length code is selected at least in part based upon at least one of criteria selected from the group consisting of the position of the coefficient corresponding to the start of a run of zero-valued significance values, and the position of the last non-zero coefficient in a corresponding block of the base layer or previous quality enhancement layers.

18. The computer program product of claim 17, wherein a mapping of context criteria for an optimal code is decoded from the bit stream.

19. The computer program product of claim 18, wherein the context mapping comprises a monotonic function.

20. The computer program product of claim 15, wherein an end-of-block marker, indicating the absence of significant coefficients in the remaining positions of the block, is allocated a symbol in the first variable-length code.

21. An electronic device, comprising:
a processor; and
a memory unit communicatively connected to the processor and including:
computer code for receiving a video portion including a base layer and a quality enhancement layer;
computer code for decoding significance values from the quality enhancement layer using a first variable-length code, the significance values indicating whether coefficients that were zero in the base layer and any previous enhancement layers are non-zero in the quality enhancement layer; and
computer code for decoding from the quality enhancement layer refinement bits using a second variable-length code, the refinement bits enabling coefficients that were non-zero in the base layer or any previous enhancement layer to be represented with greater precision.

22. The electronic device of claim 21, wherein at least one of the first and second variable length codes comprises a structured code, the structured code selected from the group consisting of a Golomb code and a start-step-stop code.

23. The electronic device of claim 21, wherein the memory unit further comprises:
computer code for decoding a coded flag for each macroblock in the quality enhancement layer if a coded flag for a corresponding macroblock in the base layer indicates that the corresponding macroblock in the base layer has not been decoded; and
computer code for each macroblock in the quality enhancement layer having a corresponding coded flag that has been decoded, decoding a coded block pattern using a third variable length code for each block within the respective macroblock,
wherein the coded block pattern is formed using only those blocks that were not coded in the base layer or previous quality enhancement layers.

24. The electronic device of claim 23, wherein the third variable length code used in decoding is selected at least in part based upon at least one of criteria selected from the group consisting of the number of bits in the coded block pattern and the probability of a bit in the coded block pattern being equal to one.

25. The electronic device of claim 21, wherein decoding of significance values includes:
decoding a run of zero-valued significance values; and
terminating non-zero valued significance values.

26. The electronic device of claim 25, wherein decoding the significance values includes:
an initial pass in which the magnitude of the terminating significance value is assumed to be one; and
zero or more subsequent passes in which the magnitude of terminating significance values is refined.

27. The electronic device of claim 21, wherein the first variable length code is selected at least in part based upon at least one of criteria selected from the group consisting of the position of the coefficient corresponding to the start of a run of zero-valued significance values, and the position of the last non-zero coefficient in a corresponding block of the base layer or previous quality enhancement layers.

28. The electronic device of claim 27, wherein a mapping of context criteria for an optimal code is decoded from the bit stream.

29. The electronic device of claim 25, wherein an end-of-block marker, indicating the absence of significant coefficients in the remaining positions of the block, is allocated a symbol in the first variable-length code.

30. A method of encoding quality enhancement information in a video portion using variable length codes, comprising:
encoding significance values into a quality enhancement layer of the video portion using a first variable-length code, the significance values indicating whether coefficients that were zero in a base layer of the video portion and any previous enhancement layers of the video portion are non-zero in the quality enhancement layer; and
encoding into the quality enhancement layer refinement bits using a second variable-length code, the refinement bits enabling coefficients that were non-zero in the base layer or any previous enhancement layer to be represented with greater precision.

31. The method of claim 30, wherein at least one of the first and second variable length codes comprises a structured code, the structured code selected from the group consisting of a Golomb code and a start-step-stop code.

32. The method of claim 31, further comprising:
encoding a coded flag for each macroblock in the quality enhancement layer if a coded flag for a corresponding macroblock in the base layer indicates that the corresponding macroblock in the base layer has not been encoded; and
for each macroblock in the quality enhancement layer having a corresponding coded flag that has been encoded, encoding a coded block pattern using a third variable length code for each block within the respective macroblock,
wherein the coded block pattern is formed using only those blocks that were not coded in the base layer or previous quality enhancement layers.

33. The method of claim 32, wherein the third variable length code is selected at least in part based upon at least one of criteria selected from the group consisting of the number of bits in the coded block pattern and the probability of a bit in the coded block pattern being equal to one.

34. The method of claim 30, wherein the first variable length code is selected at least in part based upon at least one of criteria selected from the group consisting of the position of the coefficient corresponding to the start of a run of zero-valued significance values, and the position of the last non-zero coefficient in a corresponding block of the base layer or previous quality enhancement layers.

35. The method of claim 34, wherein a mapping of context criteria for an optimal code is encoded into the bit stream.

36. The method of claim 35, wherein the context mapping comprises a monotonic function.

37. The method of claim 34, wherein an end-of-block marker, indicating the absence of significant coefficients in the remaining positions of the block, is allocated a symbol in the first variable-length code.

38. A computer program product for encoding quality enhancement information in a video portion using variable length codes, comprising:
computer code for encoding significance values into a quality enhancement layer of the video portion using a first variable-length code, the significance values indicating whether coefficients that were zero in a base layer of the video portion and any previous enhancement layers of the video portion are non-zero in the quality enhancement layer; and
computer code for encoding into the quality enhancement layer refinement bits using a second variable-length code, the refinement bits enabling coefficients that were non-zero in the base layer or any previous enhancement layer to be represented with greater precision.

39. The computer program product of claim 38, wherein at least one of the first and second variable length codes comprises a structured code, the structured code selected from the group consisting of a Golomb code and a start-step-stop code.

40. The computer program product of claim 39, further comprising:
computer code for encoding a coded flag for each macroblock in the quality enhancement layer if a coded flag for a corresponding macroblock in the base layer indicates that the corresponding macroblock in the base layer has not been encoded; and
computer code for, for each macroblock in the quality enhancement layer having a corresponding coded flag that has been encoded, encoding a coded block pattern using a third variable length code for each block within the respective macroblock,
wherein the coded block pattern is formed using only those blocks that were not coded in the base layer or previous quality enhancement layers.

41. The computer program product of claim 40, wherein the third variable length code is selected at least in part based upon at least one of criteria selected from the group consisting of the number of bits in the coded block pattern and the probability of a bit in the coded block pattern being equal to one.

42. The computer program product of claim 38, wherein the first variable length code is selected at least in part based upon at least one of criteria selected from the group consisting of the position of the coefficient corresponding to the start of a run of zero-valued significance values, and the position of the last non-zero coefficient in a corresponding block of the base layer or previous quality enhancement layers.

43. The computer program product of claim 42, wherein a mapping of context criteria for an optimal code is encoded into the bit stream.

44. The computer program product of claim 43, wherein the context mapping comprises a monotonic function.

45. The computer program product of claim 42, wherein an end-of-block marker, indicating the absence of significant coefficients in the remaining positions of the block, is allocated a symbol in the first variable-length code.

46. An electronic device, comprising:
a processor; and
a memory unit communicatively connected to the processor and including:
computer code for encoding significance values into a quality enhancement layer of a video portion using a first variable-length code, the significance values indicating whether coefficients that were zero in a base layer of the video portion and any previous enhancement layers of the video portion are non-zero in the quality enhancement layer; and
computer code for encoding into the quality enhancement layer refinement bits using a second variable-length code, the refinement bits enabling coefficients that were non-zero in the base layer or any previous enhancement layer to be represented with greater precision.

47. The electronic device of claim 46, wherein at least one of the first and second variable length codes comprises a structured code, the structured code selected from the group consisting of a Golomb code and a start-step-stop code.

48. The electronic device of claim 47, wherein the memory unit further comprises:
computer code for encoding a coded flag for each macroblock in the quality enhancement layer if a coded flag for a corresponding macroblock in the base layer indicates that the corresponding macroblock in the base layer has not been encoded; and
computer code for, for each macroblock in the quality enhancement layer having a corresponding coded flag that has been encoded, encoding a coded block pattern using a third variable length code for each block within the respective macroblock,
wherein the coded block pattern is formed using only those blocks that were not coded in the base layer or previous quality enhancement layers.

49. The electronic device of claim 48, wherein the third variable length code is selected at least in part based upon at least one of criteria selected from the group consisting of the number of bits in the coded block pattern and the probability of a bit in the coded block pattern being equal to one.

50. The electronic device of claim 46, wherein the first variable length code is selected at least in part based upon at least one of criteria selected from the group consisting of the position of the coefficient corresponding to the start of a run of zero-valued significance values, and the position of the last non-zero coefficient in a corresponding block of the base layer or previous quality enhancement layers.

51. The electronic device of claim 50, wherein a mapping of context criteria for an optimal code is encoded into the bit stream.

52. The electronic device of claim 50, wherein an end-of-block marker, indicating the absence of significant coefficients in the remaining positions of the block, is allocated a symbol in the first variable-length code.
